(19) United States
(12) Patent Application Publication
(10) Pub. No.: US 2008/0128057 A1
(43) Pub. Date: Jun. 5, 2008

(54) Process of and device for induction-hardening helical springs

(76) Inventors: Thorsten Hufnagel, Eslohe (DE); Rudolf Bonse, Attendorn (DE)

Correspondence Address: WYATT, GERBER & O'ROURKE, 99 PARK AVENUE, NEW YORK, NY, 10016, US

(21) Appl. No.: 11/980,982

(22) Filed: Oct. 31, 2007

(30) Foreign Application Priority Data
Oct. 31, 2006 (DE) 102006051886.1-24

(51) Int. Cl. C21D 9/02; C21D 1/18; H05B 6/10; C21D 1/42

(52) U.S. Cl. 148/567; 219/635; 219/647; 219/653

(57) ABSTRACT

A process of induction-heating helical springs, more particularly valve springs, for the purpose of carrying out subsequent hardening by quenching and tempering, wherein the helical springs, while being individually fixed and rotatingly driven, are guided through an electro-magnetic alternating field.

### FIELD OF THE INVENTION

The invention relates to a process of and device for induction-heating helical springs, more particularly valve springs, for the purpose of carrying out subsequent hardening by quenching and subsequent tempering by renewed heating, generally referred to as quenching and tempering.

### BACKGROUND OF THE INVENTION

In the case of induction heating components consisting of iron for the purpose of carrying out subsequent hardening by quenching, an electro-magnetic alternating field ensures rapid reproducible heating to 850 to 1000° C. in order to produce austenite (γ-iron). If subsequently cooled rapidly to a temperature below 250° C., the γ-iron is converted into martensite, i.e. the carbon atoms are finely distributed and fixed in the resulting α-iron. The conversion of the iron, i.e. the hardening process, also depends on the cooling speed. As a rule, hardening is followed by a renewed heating and temperature-holding process, i.e. tempering at tempering temperature of 370 to 500° C.

In the case of components in the form of helical springs, more particularly valve springs, it is difficult to reliably cover the entire material surface by induction-heating.

From WO 205 081586 A1 there is known to be a process of induction-heating helical springs, wherein the helical springs with horizontal central axes are guided upwardly at an angle in a discontinuous movement by a step conveyor through an annular, closed induction coil.

### OBJECT OF THE INVENTION

It is an object of the present invention to provide an improved process and an improved device for induction heating and induction hardening or hardening and tempering helical springs, and more particularly valve springs.

### SUMMARY OF THE INVENTION

The invention relates to a method and device related to a process of induction heating helical springs, more particularly valve springs, for the purpose of carrying out hardening by quenching and subsequent tempering by renewed heating, overall referred to as quenching and tempering, wherein the helical springs while being individually fixed and rotatingly driven, are guided through an electro-magnetic alternating field. More particularly, it is proposed that the helical springs are guided in a straight line through the electro-magnetic alternating field with their central axes extending parallel relative to one another. Furthermore, it is advantageous if the helical springs are guided on a substantially vertical path through the electro-magnetic alternating field with approximately horizontally extending axes.

More particularly, it is proposed that, for being fixed and rotatingly driven, the helical springs are individually placed on mandrels, with the mandrels preferably being guided in a loop with a substantially vertical plane of movement.

When placing the helical springs onto the mandrels, it is preferable to ensure that the rotatingly driven mandrels drive the helical springs without slippage of the helical springs. In addition, it is preferable to ensure that the helical springs can be removed from the mandrels in a simple way, for example by pivoting the mandrels out of the horizontal position into a downwardly pointing vertical position. Several manners of performing this function can be provided, including force-locking, such as by friction or by utilizing a form-fitting action, such as a driver.

As far as the specific process of induction heating and cooling the induction-heated helical springs is concerned, a preferred method and related device provide:

that the alternating field is operated with a frequency of 20 to 300 kHz;

that the alternating field is generated by a power of 70 to 120 kW;

that the helical springs are subjected to the alternating field for a period of 4 to 12 seconds;

that, in their boundary layer, the helical springs are heated to a temperature in excess of 850° C. and are subsequently quenched to a temperature of less than 250° C.; or

that the helical springs are heated approximately throughout to a temperature in excess of 850° C. and subsequently quenched to a temperature of less than 250° C.;

quenching can take place for example in a quenching bath containing a suitable quenching medium.

Furthermore, the invention comprises a device for induction-heating helical springs, more particularly valve springs, for the purpose of carrying out subsequent hardening by quenching and subsequent tempering by renewed heating (quenching and tempering), having individual amagnetic holding devices for helical springs, which are rotatingly drivable and can be guided, one after the other, through the electro-magnetic alternating field of an inductor assembly. It is proposed that the holding devices comprise rotatingly drivable mandrels which can be guided through the alternating field so as to extend parallel relative to one another.

It is particularly advantageous if the holding devices are arranged on members of an infinite member belt. Furthermore, it is proposed that gearwheels or friction rollers are arranged at the holding devices which can be driven by an infinite toothed belt or friction belt guided along the member belt outside the inductor assembly. In a preferred embodiment, the mandrels be comprised of an amagnetic, non-conducting material, more particularly quartz glass.

An important feature of the guidance of the helical springs is an inductor assembly which can be provided having a U-shape in a cross-section extending perpendicularly to the part of movement of the helical springs, i.e. more particularly in a horizontal section. In addition, the mandrels of the holding devices can extend between the two open legs of the “U”, preferably disposed equidistant between the two legs. It is preferable to provide a sufficient distance between the inductor assembly and the mandrels and holding devices, which can both comprise a non-conducting material or insulating material, thereby reducing any interfering factors which may adversely affect the required alternating field. It is preferable to provide that the helical springs rotate uniformly and rapidly, on their path through the alternating field whereby uniform heating on all surfaces and through-heating can be provided.

### BRIEF DESCRIPTION OF THE DRAWINGS

A preferred embodiment of the inventive device is illustrated in the drawings and will be described below.

FIG. 1 illustrates an inventive device without an inductor assembly and with conveying means (partially cut away) in 3-D illustrations.

FIG. 2 illustrates part of the device according to FIG. 1 in a plan view with the inductor assembly.

FIG. 3 illustrates part of the inductor assembly in the form of a detail in a 3-D illustration.

FIG. 4 illustrates the design principles of the inductor assembly.

### DETAILED DESCRIPTION

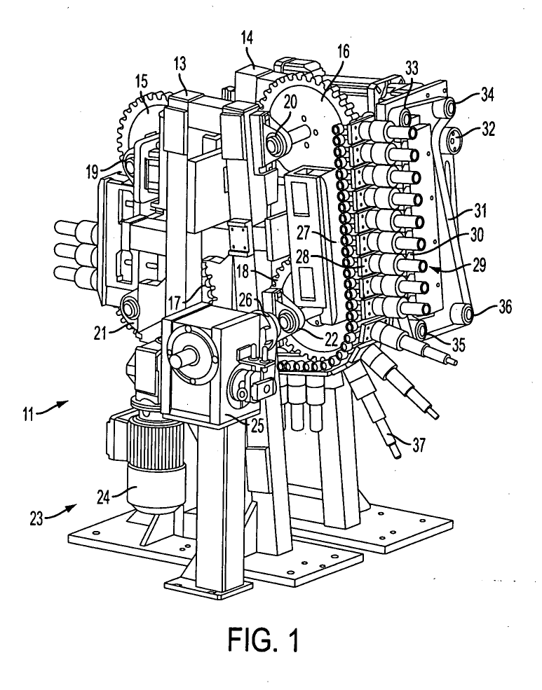

FIG. 1 shows a machine frame 11 with two stands 13, 14 between which member belt guiding means are arranged including four chain gears 15, 16, 17, 18. In each case, bearing blocks 19, 20, 21, 22 of the chain gears are provided in the front stand 13. In front of the front stand 13, a drive assembly 23 with a motor 24 is provided. In addition, a transmission 25 is provided whose output shaft, via a clutch 26, acts on the axle of the chain gear 18. Across the four chain gears, an infinite member chain 27 is provided including at least a front vertical part and a lower part deflected into the horizontal plane. The member chain 27 comprises individual chain members 28 in the shape of a rectangular plate on which centrally rotatably supported holding devices 29 are positioned whose axes of rotation are positioned normally relative to the plane of the chain members 28. In addition, it can be appreciated that a suitable rolling contact or friction bearing between a part connected to the chain member 28 and the visible part of a holding device 29 can be provided. At each of the holding devices 29, a gearwheel 30 is provided which, in the illustrated vertical region of the infinite member chain 27, can engage a toothed belt 31 which runs over deflecting rollers 33, 34, 35, 36 and can be tensioned by a tensioning roller 32. It can be appreciated that driving the toothed belt 31 by a motor (not illustrated), the holding devices 29 in the identifiable vertical part of the member chain 27 can be driven while the toothed belt 31 is engaged by the gearwheel 30. Mandrels 37 preferably comprise an amagnetic material, more particularly quartz glass, which can be inserted into three holding devices 29, which are preferably disengaged downwardly from the toothed belt 31. The helical springs to be treated can be positioned on the mandrels 37 by means of a suitable automatic handling device, and while the holding devices 29 are pivoted out of the horizontal position into a downwardly directed position, the helical springs can be thrown off and expand to a bath including a quenching liquid. The operation of placing the helical springs onto the mandrels 37 is preferably provided on a rear side of the device illustrated, which can comprise a chain portion of the member chain which shows three holding devices.

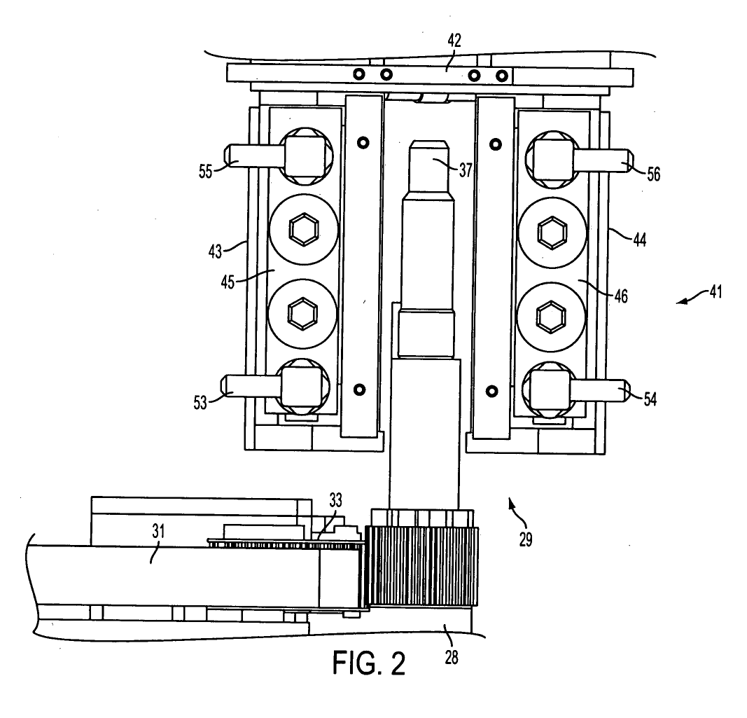

FIG. 2 shows part of the device according to FIG. 1 in a plan view. As shown, chain members 28 of the member chain 27 and holding devices 29 with an inserted mandrel 37 are provided. Also provided is a gearwheel 30 which engages the driven toothed belt 31, and an upper deflecting roller 33. By driving the toothed belt, the holding devices 29 can be made to rotate rapidly. Preferably, the toothed belt is driven in the direction opposite to the direction of the movement of the member belt 27. The holding devices 29 can be guided by an inductor assembly 41 (not shown previously) which comprises two parallel blocks 43, 44 between which an electro-magnetic alternating field can be generated. The blocks 43, 44 can be connected via a bridge element 42 to form a configuration which, in a plan view, can be U-shaped.

It can be appreciated that the inductor assembly 41 can comprise current-conducting conductor elements and cooling elements. At each of the blocks 43, 44, cooling water entry nozzles 53, 54 and cooling water exit nozzles 55, 56 can be provided.

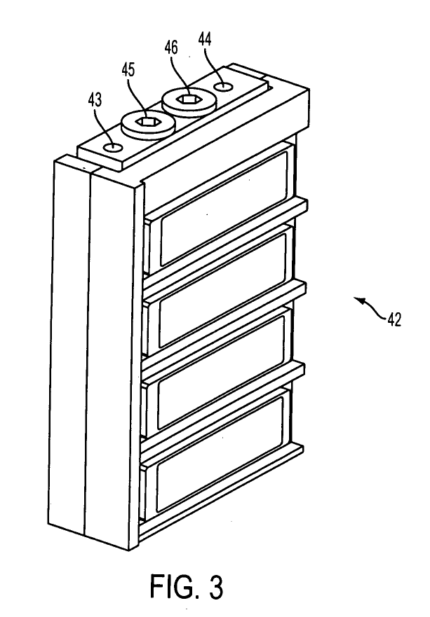

FIG. 3 shows the cooling element 46 of the block 44 in detail. Cooling water entry and cooling water exit apertures 57, 58 are shown which correspond to the above-mentioned cooling water entry and exit nozzles which, in this illustration, have been removed. On its inner side pointing towards the front, the cooling elements can comprise four U-shaped horizontally positioned receiving grooves 59, 60, 61, 62 into which current-conducting conductor elements can be provided.

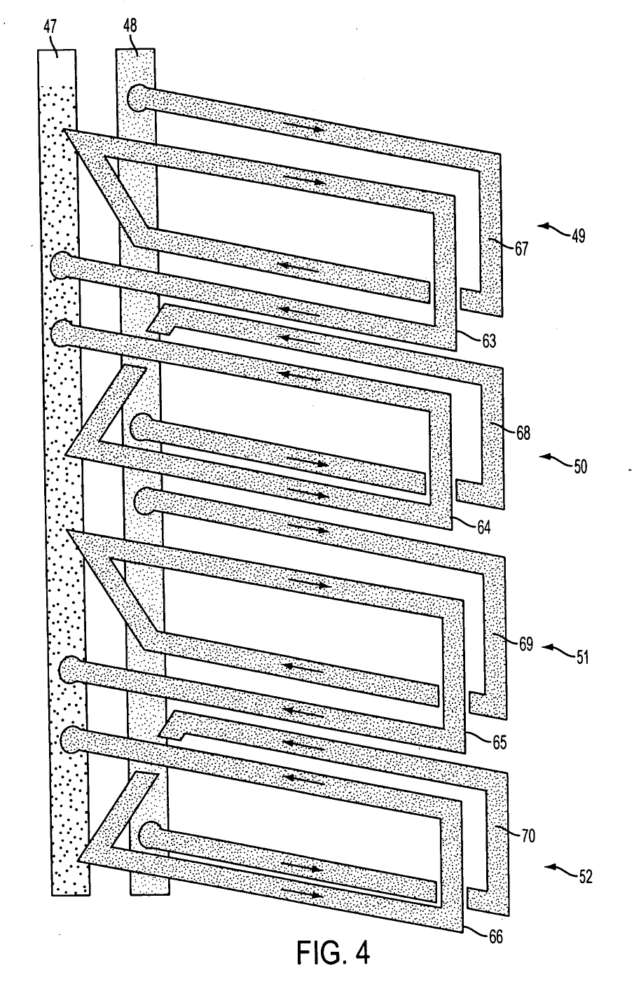

FIG. 4 shows the current-conducting conductors of the inductor assembly in detail. The current-conducting conductors of the inductor assembly comprise two electrical attaching rails 47, 48 which can be arranged in the yoke of the conductor assembly. Four conductor loops 49, 50, 51, 52 are fixed to the attaching rails and comprise left-hand U-shaped brackets 63, 64, 65, 66 for insertion into the receiving grooves of the cooling element 45, and right-hand U-shaped brackets 67, 68 69 70 for insertion into the receiving grooves of the cooling element 46. Current in the individual horizontal legs of the conductor loops is preferably provided in the direction indicted by white arrows.

1. A process of induction-heating helical springs, more particularly valve springs, comprising the steps of rotatingly driving the helical springs, and guiding the helical springs through an alternating electro-magnetic field.

2. A process according to claim 1, wherein the guiding step includes guiding the helical springs in a straight line through the electro-magnetic alternating field with their central axes extending parallel relative to one another.

3. A process according to claim 1, wherein the guiding step includes guiding the helical springs on a substantially vertical path through the electro-magnetic alternating field with approximately horizontally extending axes.

4. A process according to claim 1, wherein the rotatingly driving step includes rotatingly driving the helical springs individually on mandrels.

5. A process according to claim 4, wherein the driving step includes guiding the mandrels in an infinite loop with a substantially vertical plane of movement.

6. A process according to claim 1, further comprising providing the alternating field with a frequency of 20 to 300 kHz.

7. A process according to claim 1, further comprising generating the alternating field with a power of 70 to 120 kW.

8. A process according to claim 1, wherein the guiding step includes guiding the helical springs through the alternating field for a period of 4 to 12 seconds.

9. A process according to claim 1, further comprising heating the helical springs to a temperature of at least 850° C. in a boundary layer of the helical springs and are subsequently quenching the helical springs to a temperature of less than 250° C.

10. A process according to claim 1, further comprising heating the helical springs substantially throughout to a temperature of at least 850° C. and subsequently quenching the helical springs to a temperature of less than 250° C.

11. A process according to claim 1, further comprising the step of individually fixing the helical springs.

12. A device for induction-heating helical springs in an inductor assembly, comprising a plurality of individual amagnetic holding devices (29) for helical springs, wherein the holding devices are rotatingly drivable and can be guided, one after the other, through an electro-magnetic alternating field of the inductor assembly (41).

13. A device according to claim 12, wherein the plurality of holding devices (29) comprise a plurality of rotatingly drivable mandrels (37) which can be guided through the alternating field so as to extend parallel relative to one another.

14. A device according to claim 12, wherein the holding devices (29) are arranged on members (28) of an infinite member belt.

15. A device according to claim 12, wherein the holding devices (29) comprise a selection of gearwheels (30) or friction rollers which can be driven by an infinite toothed belt guided along the member belt (28) outside the inductor assembly (41).

16. A device according to claim 13, wherein the mandrels (37) of the holding devices (29) comprise a substantially amagnetic, non-conducting material.

17. A device according to claim 11, further comprising an inductor assembly (41) having a U-shape and forming two planar-parallel legs (42, 43), in a cross-sectional view extending perpendicularly to the direction of movement of the holding devices (29).

18. A device according to claim 12, wherein the helical springs are valve springs.

19. A device according to claim 16, wherein the amagnetic, non-conducting material comprises quartz glass.

20. A device according to claim 12, wherein the holding devices (29) comprise a selection of gearwheels (30) or friction rollers which can be driven by a friction belt guided along the member belt (28) outside the inductor assembly (41).
